(19) United States
(12) Patent Application Publication
(10) Pub. No.: US 2009/0240792 A1
(43) Pub. Date: Sep. 24, 2009

(54) METHOD AND SYSTEM FOR TRANSMITTING DHCP MESSAGE VIA PPP LINK AND FOR OBTAINING CONFIGURATION INFORMATION

(75) Inventor: Wei REN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/464,559

(22) Filed: May 12, 2009

Related U.S. Application Data
(63) Continuation of application No. PCT/CN2007/003153, filed on Nov. 7, 2007.

(30) Foreign Application Priority Data
Nov. 13, 2006 (CN) 200610146665.9

(51) Int. Cl. G06F 15/177; G06F 15/16

(52) U.S. Cl. 709/221; 709/245

(57) ABSTRACT

A method and system for transmitting DHCP message via PPP link and of obtaining configuration information are provided. In the method and the system, when an end of PPP link sends DHCP broadcasting message directly through PPP link, address of hardware desired in DHCP message is replaced by a symbol of uniquely indicating the device using PPP link, so that the PPP link can support DHCP. The symbol of uniquely indicating the device using PPP link may be identifier of devices as well as link number of PPP link and so on. Assigning strategy which binds configuration information of lower device and PPP link can make device configuration correlate to physical address.

### CROSS-REFERENCE TO RELATED APPLICATIONS

This application is a continuation of International Patent Application No. PCT/CN2007/003153, filed Nov. 7, 2007, which claims priority to Chinese Patent Application No. 200610146665.9, filed Nov. 13, 2006, both of which are hereby incorporated by reference in their entirety.

### BACKGROUND OF THE INVENTION

The present invention relates to the field of communications, and more particularly to a communication technology based on point-to-point protocols.

### DESCRIPTION OF THE RELATED ART

3G is the abbreviation for the 3rd Generation, indicating mobile communication technology of the third generation. In comparison with analog mobile communication technology of the first generation, digital mobile communication technologies such as Global System for Mobile Communications (GSM) and Code Division Multiple Access (CDMA) of the second generation, 3G generally means the new generation mobile communications system that combines wireless communication with such multimedia communications as the Internet. It is possible through 3 G to process a plurality of media forms such as images, music, and video streams, and provide a plurality of information services including webpage browsing, teleconference, and electronic business.

The network side in a 3G system includes a base station controller and base stations. Each base station receives user device signals within its range of management, and sends the processed signals collectively to the base station controller via a transmission pathway. The base station controller centrally processes the information sent from the base stations, and transmits the processed information to the user devices through the base stations.

To reduce cost of the base station controller during deployment of the network, it usually requires a base station controller to provide large-area coverage. The base station controller connects and controls multiple base stations, the base stations connected thereto may be as far as hundreds of kilometers away from the base station controller, and the base stations themselves may be distanced relatively far from one another.

In view of these requirements, it is necessary to establish a maintenance channel through which base stations are remotely accessed and maintained in an efficient and convenient manner. Protocol of the maintenance channel is referred to as Transmission Control Protocol/Internet Protocol (TCP/IP).

The maintenance channel of an IP Radio Access Network (RAN) is as shown in FIG. 1. To ensure the logic separation of functions of the devices, the base station provides an access IP, namely IP employed in specific services, and maintenance IP. The main purpose for establishing a maintenance channel lies in the necessity to acquire the address and relevant configuration of the maintenance IP.

The following is a brief introduction to Reverse Address Resolution Protocol (RARP), Bootstrap Protocol (BOOTP), Dynamic Host Configuration Protocol (DHCP), and Point-to-Point Protocol (PPP).

RARP stands for the Reverse Address Resolution Protocol that obtains the IP address through Medium Access Control (MAC) address. It is an early mode for automatically obtaining IP addresses and has been subsequently replaced by BOOTP or DHCP.

BOOTP is a relatively old system boot protocol mainly used to obtain IP addresses and initiation filenames from a server during booting up of a diskless workstation.

DHCP stands for Dynamic Host Configuration Protocol that is an evolution of BOOTP and extends BOOTP from two aspects: one aspect is to enable a computer to obtain all configuration information it requires in one message, namely a protocol that transmits configuration information; and the other aspect is to allow the computer to quickly and dynamically obtain IP addresses, namely a mechanism for dynamically assigning IP addresses.

PPP is a commonly employed IP link layer protocol, especially in the case transmission bearing is E1. The negotiation process of PPP is divided into Link Control Protocol (LCP) negotiation and Network Control Port (NCP) negotiation, of which NCP is Internet Protocol Control Protocol (IPCP) negotiation with regard to the IP protocol, and it is possible for this negotiation process to assign IP addresses of PPP.

### SUMMARY OF THE INVENTION

Various embodiments of the present invention are directed to providing a method and a system for transmitting DHCP message via a PPP link and obtaining configuration information.

Accordingly, an embodiment of the present invention provides a method for transmitting a dynamic host configuration protocol DHCP message via a point-to-point protocol PPP link. The method includes: transmitting, by an end of the PPP link, a DHCP message to be broadcast to a peer end via the PPP link upon the receipt of the DHCP message to be broadcast; and filling an identifier capable of being used for uniquely identifying the device using the PPP link, as a hardware address in the DHCP message transmitted via the PPP link, when it is necessary to fill the hardware address in the DHCP message transmitted via the PPP link.

Another embodiment of the present invention provides a method for obtaining configuration information. The method includes: requesting, by a subordinate device, a superior device for configuration information via a DHCP message on a PPP link between the subordinate device and the superior device; setting, by the superior device which uses the PPP link, an identifier capable of being used for uniquely identifying the subordinate device in the DHCP message; and transmitting in accordance with the identifier capable of being used for uniquely identifying the subordinate device which uses the PPP link, by the superior device, the requested configuration information to the subordinate device via another DHCP message on the PPP link between the superior device and the subordinate device.

Still another embodiment of the present invention provides a method for obtaining configuration information, comprising: carrying, by a superior device, configuration information in at least one predetermined negotiation parameter of Internet Control Protocol (IPCP) message when the superior device and a subordinate device connected thereto via a serial link perform IPCP layer negotiation; and transmitting, by the superior device, the configuration information to the subordinate device.

Another embodiment of the present invention provides a system for obtaining configuration information. The system includes a superior device and a subordinate device connected to each other via a PPP link.

The subordinate device includes a module adapted to request the superior device for configuration information on the PPP link via a DHCP message.

The superior device includes a module adapted to transmit to the subordinate device configuration information on the PPP link via a DHCP message.

Another embodiment of the present invention includes a system for obtaining configuration information. The system includes a superior device and a subordinate device connected to each other by a serial link.

The superior device includes a module adapted to carry configuration information in at least one predetermined negotiation parameter of an IPCP message, and transmit the configuration information to the subordinate device via a PPP link established between the superior device and the subordinate device based on IPCP layer negotiation.

The subordinate device includes a module adapted to receive the IPCP message via the PPP link between the superior device and the subordinate device, and obtain configuration information from at least one predetermined negotiation parameter of the IPCP message.

As can be seen from the technical solutions of the embodiments according to the present invention, the end of the PPP link replaces the hardware address required in the DHCP message with an identifier capable of being used for uniquely identifying the device that uses the PPP link to satisfy the requirements of DHCP on broadcasting and hardware address, so as to make it possible to support DHCP on the PPP link and transmit DHCP broadcasting message directly via the PPP link.

### BRIEF DESCRIPTION OF THE DRAWING(S)

FIG. 1 is a view illustrating a maintenance channel of IP RAN;

FIG. 2 is a structural view showing the system for obtaining configuration information according to an embodiment of the present invention;

FIG. 3 is a flowchart showing the method for obtaining configuration information according to an embodiment of the present invention;

FIG. 4 is a flowchart showing the DHCP process being performed on a PPP link according to an embodiment of the present invention; and

FIG. 5 is a flowchart showing the method for obtaining configuration information according to another embodiment of the present invention.

### DETAILED DESCRIPTION OF THE EMBODIMENTS

To make more apparent the inventive objectives, technical solutions and advantages of the present invention, the present invention is described in greater detail below with reference to the accompanying drawings.

Some solutions related to the present invention are firstly presented as follows.

### Solution 1:

The base station makes use of the NCP protocol of the PPP link to negotiate and obtain the network layer address.

As the inventors of the present invention have found, the addresses obtainable by using NCP in such a solution are limited, as it is only possible to obtain the addresses of the home end and the party end, while it is impossible to obtain other device parameters such as the IP address of the maintenance channel, the internal maintenance network segment of the device, and channel parameters, etc., and static configuration is required for those parameters. If static configuration is performed, manual labor is needed to maintain at the remote device, thus greatly increasing operational amount. In addition, there is only one address obtainable by using NCP, and access address and maintenance address of the device cannot be set as different values.

### Solution 2:

The base station makes use of ordinary DHCP to obtain information of the maintenance channel.

As the inventors found in such a solution, DHCP can currently merely support automatic configuration on an Ethernet medium, while it cannot support acquisition of configuration information on serial links such as PPP, and can hence not be applied in links such as E1/T1. This is so because DHCP requires broadcasting function, while PPP does not support the broadcasting function. Moreover, it is necessary to fill hardware address of the device, such as Medium Access Control (abbreviated as “MAC”) address, in a part of DHCP messages, while PPP does not contain hardware address. But E1/T1 are very common transmission approaches in 3G RAN, and the above defect therefore leads to restrictions in use of DHCP in RAN.

As should be explained, the PPP link as referred to in the embodiment of the present invention is a generic concept including various links employing protocols in the PPP protocol family, such as the Multi Link Point to Point Protocol (MLPPP) link and Point to Point Protocol over Ethernet (PPPoE).

An embodiment of the present invention relates to a technical solution of transmitting a DHCP message on a PPP link, as well as a technical solution of obtaining configuration information of a device on the PPP link via the DHCP message.

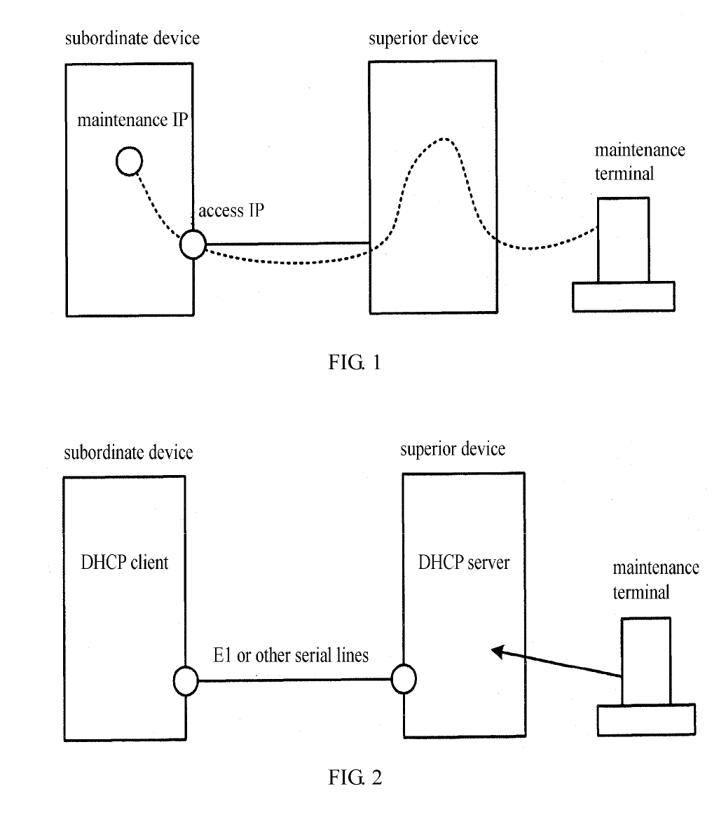

Structure of the system for obtaining configuration information is as shown in FIG. 2, including a superior device and a subordinate device connected via the PPP link to each other.

The subordinate device includes a module adapted to request the superior device for configuration information on the PPP link via the DHCP message, and the superior device includes a module adapted to transmit the configuration information to the subordinate device on the PPP link via the DHCP message. The PPP link between the superior and subordinate devices may be established on any serial line, including, but not limited to, RS232 serial port, E1, T1, J1, E3, T3, etc.

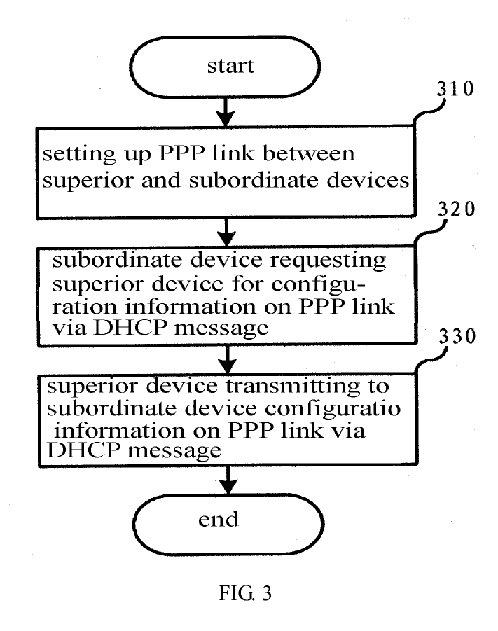

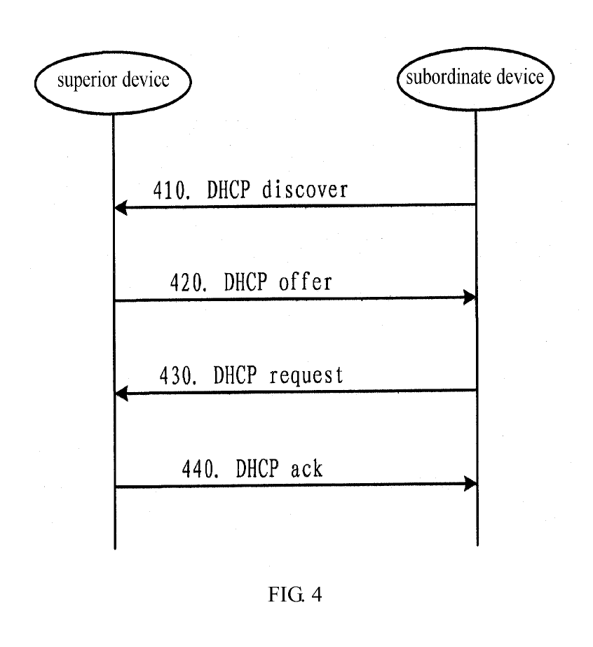

The process that the subordinate device obtains configuration information from the superior device is as shown in FIG. 3.

A PPP link is established between the superior and subordinate devices in Block 301.

Specifically, the PPP link may be provided on the subordinate device by default, so that the subordinate device can automatically request for PPP connection on such serial lines as E1.

In response to the request for PPP connection on such a serial line as E1, the superior device assigns such information as interface and IP address to the subordinate device by means of the standard NCP protocol of PPP.

The PPP link is established between the superior and subordinate devices through the above process. This process may be omitted if there has already been a PPP link between the superior device and subordinate device.

When the PPP link is successfully established between the subordinate device and the superior device, the procedure goes to Block 320, in which the subordinate device requests the superior device for configuration information on the PPP link via the DHCP message.

Subsequently the procedure goes to Block 330, in which the superior device transmits the configuration information to the subordinate device on the PPP link through the DHCP message.

Both Block 320 and Block 330 involve transmitting the DHCP message on PPP. The existing DHCP can generally be supported by the Ethernet link only. DHCP cannot be supported on the PPP link mainly because of the following two aspects: (1) DHCP needs broadcast, whereas there is no broadcasting function on the PPP link; (2) DHCP requires hardware address, and the hardware address in the Ethernet link is the MAC address, whereas there is no MAC address in the PPP link. Accordingly, when the DHCP message is transmitted on the PPP link, it is necessary to extend DHCP to certain extent. Frame structure of a conventional art DHCP is as shown in Table 1.

TABLE 1

| | | | |
|---|---|---|---|
| op(1) operation | htype (1) type of | hlen (1) length of | Hops (1) |
| code | hardware address | hardware address | number of hops |

xid (4) transaction number

| | |
|---|---|
| secs (2) number of seconds | flags (2) bits |

ciaddr (4) original address of client
yiaddr (4) address assigned by server
siaddr (4) server address of diskless workstation
giaddr (4) gateway address
chaddr (16) hardware address
sname (64) server name
file (128) program name of diskless booting
options (312) extended options

The embodiment of the present invention solves the problem concerning support of DHCP by PPP with the following method.

When an end of the PPP link receives a DHCP message to be broadcast, it transmits the DHCP message to a peer end via the PPP link.

When it is necessary for the hardware address (chaddr) to be filled in the DHCP message transmitted via the PPP link, an identifier capable of being used for uniquely identifying the device, which uses the PPP link, is filled in the DHCP message as the hardware address.

When the DHCP server assigns IP address to the device, the identifier capable of being used for uniquely identifying the device in the DHCP message is bound with the IP address assigned to the device.

The identifier capable of being used for uniquely identifying the PPP link includes one of the following: (1) a marker preset in the device, which can be set by other protocols and is preferably unique in the whole network; (2) a link number of the PPP link of superior device, suitable for the case in which there is only one DHCP client device on each PPP link; and (3) a physical port serial number of the PPP link.

When the identifier capable of being used for uniquely identifying the device that uses the PPP link is filled as the hardware address in the DHCP message, it can be filled by the device located at a side of the PPP link transmitting the DHCP message, or can also be filled by the device located at a side of the PPP link receiving the DHCP message, or can also be filled on both sides. The solution of filling on both sides is good in compatibility in the case that devices of different manufactures are combined to deploy the network and there is no need to worry that relevant information fails to be input in the devices of other factories at the peer end as required by the current manufacturer.

An embodiment of DHCP interactive process on the PPP link is shown in FIG. 4, wherein definition of the DHCP message can be found in standard protocols such as RFC1541.

At 410, the subordinate device sends out DHCP DISCOVER message on the PPP link already established. The IP address of the subordinate device itself is filled in the address of the current PPP port.

The process goes to 420, in which the superior device receives the DHCP DISCOVER message on the PPP link, and fills in the PPP link identifier upon receipt.

The superior device assigns the maintenance IP address in accordance with an IP address assigning algorithm and bind the assigned maintenance IP address with the hardware address (in this embodiment, a PPP link identifier) in the DHCP DISCOVER message, and then transmits DHCP OFFER message to the subordinate device via the PPP link. Server address in the message can be filled with the address of one end of the PPP link and client address in the message can be filled with the address of the other end of the PPP link; alternatively, server address and client address in the message may not be filled at all.

The process subsequently goes to 430, in which the subordinate device receives the DHCP OFFER message, and then sends DHCP request message to request the superior device for configuration information.

Going then to 440, the superior device receives the request from the subordinate device, sends DHCP ACK message to the subordinate device, and the configuration information, for example, the maintenance IP address, of the device can be carried in the extended options of DHCP. Alternatively, it is also possible to carry the configuration information of the device by means of other fields of DHCP response, such as the fields of sname or the fields of file.

The present embodiment does not put specific requirements on the superior and subordinate devices. By way of an example, the superior device may be a base station controller, and the subordinate device may be a base station. Setup of the base station can be accomplished by defining the OPTION field of the DHCP frame to obtain the addresses of the maintenance IP and the access IP all at once.

The type of Option employed in one concrete example is 43, as shown in Table 2. Specific contents of self-defined Option fields are as shown in Table 3.

TABLE 2

| | | Self-defined | |
|---|---|---|---|
| Option Type | | Magic Character | Self-defined |
| (1 byte) | Length | (4 bytes) | Field Types |
| 43 | the whole length of | 0xDEADBEAF | See Table 3 |
| | the extended option | | |

TABLE 3

| Type id | Length | Explanations of Values |
|---|---|---|
| 1 | 16 | unique identifier of base station |
| 2 | 1 | port type from request of base |
| | | station, fe/ppp/mp/ . . . |
| 3 | length of IP address | maintenance IP of base station |
| 4 | length of IP mask code | maintenance IP mask code of base |
| | | station |
| 5 | length of IP address | peer end IP of maintenance channel |
| | | of base station |
| 6 | length of IP mask code | peer end IP mask code of maintenance |
| | | channel of base station |
| 7 | length of IP address | obtaining server address configured |
| | | on base station |
| 8 | Indefinite, 100 bytes | obtaining FTP path configured on |
| | maximum | base station, a valid pathname |
| 9 | Indefinite, 16 bytes | obtaining FTP username configured |
| | maximum | on base station |
| 10 | Indefinite, 16 bytes | obtaining FTP password configured |
| | maximum | on base station |

The base station can obtain all configuration information required by the maintenance channel all at once through the DHCP process on PPP, so that it is possible to automatically obtain configuration information of the device via PPP on such serial links as E1/T1, thus it can greatly reduce the operational amount of manual maintenance, allow good compatibility of protocols, make full use of support from the currently available DHCP protocols, and enable the use of existent DHCP management and maintenance tools.

As a preferred solution in the present embodiment, the base station obtains all configuration information required by the maintenance channel all at once, but the embodiments of the present invention is not limited thereto, as it is also possible to accomplish transmission of the configuration information in several times, and only a part of the configuration information is transmitted in each DHCP process.

Another embodiment of the present invention makes improvement over the above embodiment. The system for obtaining configuration information as proposed in the above embodiment includes a superior device and a subordinate device connected to each other via a PPP link, of which the subordinate device includes a module adapted to request the superior device for configuration information on the PPP link via a DHCP message, and the superior device includes a module adapted to transmit to the subordinate device configuration information on the PPP link via a DHCP message. The PPP link of the superior and subordinate devices can be established on any serial line, which includes, but is not limited to, RS232 port, E1, T1, J1, E3, T3, etc.

In addition, the superior device and/or the subordinate device can further include a module adapted to add an identifier of the PPP link to the DHCP message upon transmission of the DHCP message for requesting the configuration information from the subordinate device to the superior device.

The superior device may further include a module adapted to transmit to the subordinate device configuration information corresponding to the identifier of the PPP link via a DHCP message, according to the identifier of the PPP link in the DHCP message from the subordinate device for requesting the configuration information.

The process of obtaining the configuration information is described below.

When the superior device and/or the subordinate device transmit(s) the DHCP message carrying the configuration information requested by the subordinate device from the superior device, an identifier capable of being used for uniquely identifying the PPP link is added to the DHCP message.

The superior device transmits configuration information corresponding to the identifier capable of being used for uniquely identifying the PPP link to the subordinate device via the DHCP message.

For example, when the superior device receives the DHCP DISCOVER message, it fills the hardware address with the PPP link number in the DHCP DISCOVER message in accordance with the PPP link of the DHCP DISCOVER message, finds out the corresponding configuration information in accordance with the PPP link number, and carries the configuration information to the subordinate device via the DHCP ACK message.

By employing the assignment strategy of binding the configuration information of the subordinate device with the PPP link number, it is possible to achieve correlation between the configuration information of the device and the physical location of the PPP link, so that there is no need for maintenance operation during replacement of devices in the original site or change of locations of the original device, and the configuration information of the device can be automatically obtained in accordance with the physical location. Thus, during configuration of the whole network, once central device nodes are configured, all subordinate nodes can automatically obtain configuration information, thereby greatly reducing configuration conflict and the operational amount of configuration.

Another embodiment of the present invention involves the technical solution of obtaining configuration information of the device on the PPP link via the DHCP message.

Structure of the system for obtaining configuration information is as shown in FIG. 2. It includes a superior device and a subordinate device connected to each other via a serial link, which includes, but is not limited to, RS232 port, E1, T1, J1, E3, T3, etc.

Both the superior and subordinate devices include modules adapted to establish the PPP link via IPCP layer negotiation.

The superior device further includes a module adapted to carry configuration information in at least one predetermined negotiation parameter of an IPCP message, and transmit the configuration information to the subordinate device via the PPP link between the superior device and the subordinate device.

The subordinate device further includes a module adapted to receive the IPCP message via the PPP link between the superior device and the subordinate device, and obtain configuration information from at least one predetermined negotiation parameter in the IPCP message.

Like the case in the previous embodiment, this embodiment does not put specific requirements on the superior and subordinate devices. By way of an example, the superior device may be a base station controller, the subordinate device may be a base station, and the configuration information may be required by the maintenance channel of the base station.

The superior and subordinate devices of the system adapted to obtain configuration information may not include the module adapted to establish the PPP link through IPCP layer negotiation, but at this time a PPP link capable of being used for communication is required between the superior device and the subordinate device.

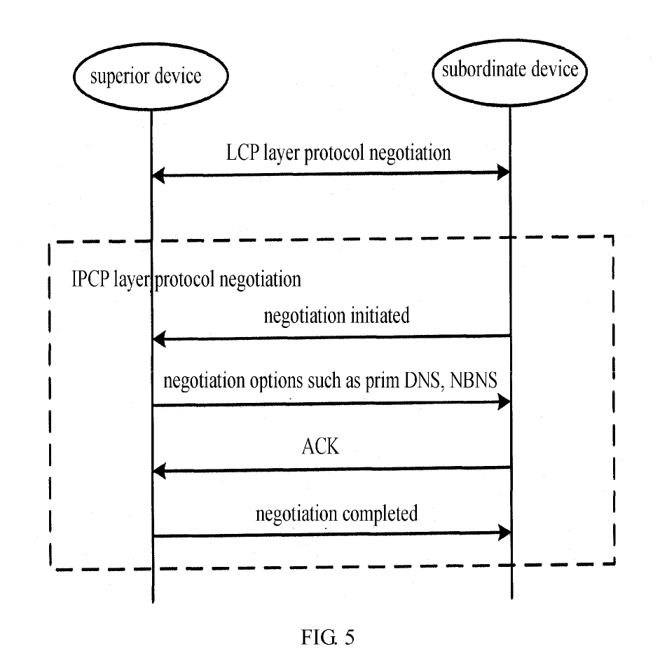

As shown in FIG. 5, the superior and the subordinate devices firstly perform LCP layer negotiation. IPCP layer negotiation is performed after LCP layer negation is finished. During IPCP layer negotiation, the superior device carries the configuration information in at least one predetermined negotiation parameter of the IPCP message and transmits the information to the subordinate device.

IPCP layer negotiation includes the following steps.

The subordinate device sends a negotiation initiating message to the superior device.

Upon receipt of the negotiation initiating message, the superior device carries such negotiation parameter options as Primary DNS Server Address, Primary NBNS Server Address, Secondary DNS Server Address, and Secondary NBNS Server Address in the message in response to the subordinate device, and carries in these negotiation options the configuration information required by the subordinate device.

Upon receipt of the negotiation options, the subordinate device obtains the configuration information from the parameter options of Primary DNS Server Address, Primary NBNS Server Address, Secondary DNS Server Address, and Secondary NBNS Server Address, and replies a response message ACK.

Upon receipt of ACK, the superior device sends a negotiation completion message to the subordinate device.

In order to avoid misuse of the address during docking with the general PPP interface device, a special IP address or a special rule can be agreed upon for definition and authentication. For instance, 172.168.89.89 can be used as a special Primary DNS Server Address indicating that what is carried is the configuration information of the maintenance channel.

The method of address verification can also be used to verify Primary DNS Server Address (or any other negotiation address) and Secondary DNS Server Address by certain rules, for instance, an invariant special numerical value can be set as the difference of subtracting Secondary DNS Server Address from Primary DNS Server Address, so as to achieve the objective of making sure what is transmitted is the configuration information of the maintenance channel.

If it is found that the obtained information does not conform to the predetermined rules, it will be decided not to use the negotiation options, at which time the subordinate device can sent out a NACK response to the corresponding options.

In this embodiment the superior device may carry the configuration information through negotiation parameters which are not used during IPCP layer negation to achieve automatic configuration of the subordinate device. Such a solution has wide application, and may use standard protocols, and modification may be made on the protocol configuration without modifying the protocols themselves. In practical application, a subordinate device configured in this way can be docked with a superior device carrying configuration information, and can also be docked with an ordinary PPP peer end device.

As can be seen from the technical solutions of the embodiments of the present invention, the end of the PPP link replaces the hardware address required in the DHCP message with an identifier capable of being used for uniquely identifying the device that uses the PPP link to satisfy the requirements of DHCP on broadcasting and hardware address, so as to make it possible to support DHCP on the PPP link and transmit DHCP broadcasting message directly via the PPP link.

The identifier capable of being used for uniquely identifying the device that uses the PPP link can be a marker of the device, and can also be a link number of the PPP link. The implementation mode thereof is very flexible.

The base station can obtain all configuration information required by the maintenance channel all at once through the DHCP process on the PPP link, so that it is possible to automatically obtain configuration information of the device via PPP on such serial links as E1/T1, greatly reduce the operational amount of manual maintenance, allow good compatibility of protocols, make full use of support from the currently available DHCP protocols, and enable the use of existent DHCP management and maintenance tools.

By using the link number of the PPP link as the identifier capable of being used for uniquely identifying the device that uses the PPP link, and by employing the assignment strategy of binding the configuration information of the subordinate device with the PPP link number, it is possible to achieve correlation between the configuration information of the device and the physical location of the PPP link, so that there is no need for maintenance operation during replacement of devices in the original site or change of locations of the original device, because these can be automatically obtained. Thus, during configuration of the whole network configuration is only needed on the central device nodes, and all subordinate nodes may automatically obtain configuration information, thereby greatly reducing configuration conflict and the work of configuration.

The superior device may carry the configuration information through negotiation parameters usually not used during IPCP layer negation to achieve automatic configuration of the subordinate device. Such a solution has wide application, and can use standard protocols, and modification may be made on the protocol configuration without modifying the protocols themselves. In practical application, a subordinate device configured may be docked with a superior device that carries configuration information, and may also be docked with an ordinary PPP peer end device.

Although the present invention has been illustrated and described with reference to exemplary embodiments in the present invention, it should be understood to persons skilled in the art that various variations and modifications can be made to the present invention both in form and in details without departing from the principle and scope of the present invention.

To be noted, the present invention may also be adapted to computer program for carrying out the above mentioned method and computer readable record medium having the computer program thereon. The computer readable record medium may include computer readable floppy disk, hard disk, semiconductor memory, CD-ROM, DVD, Magnetic Optical (MO) and other mediums.

What is claimed is:

1. A method for transmitting a dynamic host configuration protocol, DHCP, message via a Point-to-Point Protocol, PPP, link, comprising:
transmitting, by an end of the PPP link, a DHCP message to be broadcast to a peer end via the PPP link upon the receipt of the DHCP message to be broadcast; and
filling an identifier capable of being used for uniquely identifying a device which uses the PPP link, as a hardware address in the DHCP message transmitted via the PPP link when it is necessary to fill the hardware address in the DHCP message transmitted via the PPP link.

2. The method for transmitting a DHCP message via a PPP link according to claim 1, further comprising:
assigning an Internet Protocol, IP, address to the device upon the receipt of the DHCP message containing the hardware address; and
binding, by a DHCP server, the identifier capable of being used for uniquely identifying the device as the hardware address in the DHCP message with the IP address assigned to the device.

3. The method for transmitting a DHCP message via a PPP link according to claim 1, wherein, the identifier capable of being used for uniquely identifying the device, which uses the PPP link, is filled as the hardware address in the DHCP message by at least one of the following devices:
a device at a side of the PPP link transmitting the DHCP message;
a device at a side of the PPP link receiving the DHCP message; and
a device at a side of the PPP link transmitting the DHCP message and a device at a side of the PPP link receiving the DHCP message.

4. The method for transmitting a DHCP message via a PPP link according to claim 1, wherein the identifier capable of being used for uniquely identifying the device, which uses the PPP link, comprises one of:
a unique marker preset in the device;
a link number of the PPP link; and
a physical port serial number of the PPP link.

5. A method for obtaining configuration information, comprising:
requesting, by a subordinate device, a superior device for configuration information via a DHCP message on a Point-to-Point Protocol, PPP, link between the subordinate device and the superior device;
setting, by the superior device and/or the subordinate device, an identifier capable of being used for uniquely identifying the subordinate device which uses the PPP link in the DHCP message; and
transmitting in accordance with the identifier capable of being used for uniquely identifying the subordinate device which uses the PPP link, by the superior device, the requested configuration information to the subordinate device via another DHCP message on the PPP link between the superior device and the subordinate device.

6. The method for obtaining configuration information according to claim 5, wherein the process of transmitting the requested configuration information comprises:
including all configuration information in an “OPTION” field type in the DHCP message and transmitting the configuration information to the superior device.

7. The method for obtaining configuration information according to claim 6, wherein the “OPTION” field type comprises one of the following or any combination thereof:
a first field indicative of an identification number of the current DHCP process and the length of the first field;
a second field indicative of the type of a port through which the request is transmitted by the subordinate device and the length of the second field;
a third field indicative of an assigned maintenance IP address and the length of the third field;
a fourth field indicative of a mask code of the assigned maintenance IP address and the length of the fourth field;
a fifth field indicative of an assigned access IP address and the length of the fifth field;
a sixth field indicative of a mask code of the assigned access IP address and the length of the sixth field;
a seventh field indicative of the server address of obtained configuration of the subordinate device and the length of the seventh field;
an eighth field indicative of the file transmission protocol FTP path of obtained configuration of the subordinate device and the length of the eighth field; and
a ninth field indicative of the FTP username of obtained configuration of the subordinate device and a length of the ninth field, a tenth field indicative of the FTP password of obtained configuration of the subordinate device and a length of the tenth field.

8. The method for obtaining configuration information according to claim 5, wherein the identifier capable of being used for uniquely identifying the subordinate device comprises an identifier capable of being used for uniquely identifying the PPP link; and wherein the superior device transmits configuration information corresponding to the identifier capable of being used for uniquely identifying the PPP link to the subordinate device via the another DHCP message.

9. The method for obtaining configuration information according to claim 5, wherein the superior device is a base station controller, and the subordinate device is a base station that obtains all configuration information required for establishing a maintenance channel of the base station in one DHCP process.

10. A method for obtaining configuration information, comprising:
carrying, by a superior device, configuration information in at least one predetermined negotiation parameter of Internet Protocol Control Protocol, IPCP, message when the superior device and a subordinate device connected thereto via a serial link perform IPCP layer negotiation; and
transmitting, by the superior device, the configuration information to the subordinate device.

11. The method for obtaining configuration information according to claim 10, wherein the serial link comprises one of:
an RS232 serial port, E1, T1, J1, E3 and T3.

12. The method for obtaining configuration information according to claim 10, wherein the IPCP message indicates at least one predetermined negotiation parameter in the message as carrying the configuration information by one of:
setting a specific value in the predetermined negotiation parameter; and
the value in the at least one predetermined negotiation parameter satisfying a specific verification rule.

13. The method for obtaining configuration information according to claim 10, wherein the predetermined negotiation parameter carrying the configuration information comprises one of the following or any combination thereof:
“Primary DNS Server Address”, “Primary NBNS Server Address”, “Secondary DNS Server Address”, “Secondary NBNS Server Address.”

14. A system for obtaining configuration information, comprising: a superior device and a subordinate device connected to each other via a PPP link; wherein:
the subordinate device comprises a module adapted to request the superior device for configuration information on the PPP link via a DHCP message; and
the superior device comprises a module adapted to transmit to the subordinate device configuration information on the PPP link via a DHCP message.

15. The system for obtaining configuration information according to claim 14, wherein the superior device or the subordinate device or the superior device and the subordinate device respectively further comprises a module adapted to set an identifier of the PPP link in the DHCP message; and
the superior device further comprises a module adapted to transmit to the subordinate device configuration information corresponding to the identifier of the PPP link via the DHCP message in accordance with the identifier of the PPP link in the DHCP message.

16. A system for obtaining configuration information, comprising: a superior device and a subordinate device connected to each other by a serial link; wherein:
the superior device comprises a module adapted to carry configuration information in at least one predetermined negotiation parameter of an Internet Protocol Control Protocol, IPCP, message, and transmit the configuration information to the subordinate device via a PPP link established between the superior device and the subordinate device based on IPCP layer negotiation; and
the subordinate device comprises a module adapted to receive the IPCP message via the PPP link between the superior device and the subordinate device, and obtain the configuration information from the at least one predetermined negotiation parameter of the IPCP message.

17. The system for obtaining configuration information according to claim 16, wherein the IPCP message indicates at least one predetermined negotiation parameter in the message as carrying the configuration information by one of:
setting a specific value in the predetermined negotiation parameter; and
the value in the at least one predetermined negotiation parameter satisfying a specific verification rule.

18. The system for obtaining configuration information according to claim 16, wherein the superior device is a base station controller, the subordinate device is a base station, and the configuration information is required by a maintenance channel of the base station.

19. The method for transmitting a DHCP message via a PPP link according to claim 2, wherein, the identifier capable of being used for uniquely identifying the device, which uses the PPP link, is filled as the hardware address in the DHCP message by at least one of the following devices:
a device at a side of the PPP link transmitting the DHCP message;
a device at a side of the PPP link receiving the DHCP message; and
a device at a side of the PPP link transmitting the DHCP message and a device at a side of the PPP link receiving the DHCP message.

20. The method for transmitting a DHCP message via a PPP link according to claim 2, wherein the identifier capable of being used for uniquely identifying the device, which uses the PPP link, comprises one of:
a unique marker preset in the device;
a link number of the PPP link; and
a physical port serial number of the PPP link.
